(19) United States
(12) Patent Application Publication
(10) Pub. No.: US 2004/0217505 A1
(43) Pub. Date: Nov. 4, 2004

(54) Apparatus and method for production of synthetic lightweight aggregate.

(76) Inventor: Gurbaksh Singh, Hinsdale, IL (US)

Correspondence Address: GURBAKSH SINGH, 518 W, 58TH PLACE, HINSDALE, IL, 60521, US

(21) Appl. No.: 10/249,681

(22) Filed: Apr. 30, 2003

(51) Int. Cl. B29C 33/00

(52) U.S. Cl. 264/69; 249/119; 264/333

(57) ABSTRACT

The invention provides a simple, energy efficient and direct method of producing synthetic lightweight aggregate, in spheroidal, other regular shapes or even in crushed form, in a wide range of defined sizes and target densities by preparing appropriately batched and mixed slurry mixes of cement, sand, waste materials like fly ash and/or stone dust, additives, water and preformed stable foam, transferring and then casting the slurry mix under ambient conditions, into desired sized aggregate in uniquely invented battery moulds having multiple interconnected cells, where allowing the casting to harden under ambient conditions for some time and then demoulding provides the desired quality aggregate granules.

### CROSS REFERENCE TO RELATED APPLICATIONS

U.S. Pat. No. 3,758,319, Oct. 11, 1973, Mehmet T. Ergene et. al.; U.S. Pat. No. 4,377,414, Mar. 22, 1983, Buschmann et al.; U.S. Pat. No. 4,741,782, May 3, 1988, Styron; U.S. Pat. No. 4,624,711, Nov. 25, 1986, Styron; U.S. Pat. No. 4,659,385, Apr. 21, 1987, Costopoulos et. al.; U.S. Pat. No. 4,770,931, Sept. 13, 1988, Walker; U.S. Pat. No. 5,484,479, Jan. 16, 1996, Weber; U.S. Pat. No. 5,704,972, Jan. 6, 1998, Ivkovich; U.S. Pat. No. 5,762,864, Jun. 9, 1998, Park; U.S. Pat. No. 5,772,751, Jun. 30, 1998, Nisnevich et. al.; U.S. Pat. No. 6,126,738, Oct. 3, 2000, Gerbus et. al.

### BACKGROUND OF INVENTION

U.S. Patent Classification:

106/405; 106/606; 106/664; 106/672; 106/703; 106/705; 106/817; 106/DIG.1

264/46.9; 264/71; 264/297.9; 264/299; 264/300; 264/DIG.7; 264/DIG.43; 264/DIG.49; 264/DIG.64

588/256: 588/257

1. Background

Aggregate is an essential ingredient of concrete, which in its different forms, is extensively used for all types of building and infrastructure projects. Most of the pavements and roadwork use aggregate even in the sub base as also in the topping layer even if done with bitumen. It is used as Ballast under railway tracks. It is also used for consolidation of weak soils, formation of filter beds etc. Lightweight aggregate also finds application in insulation, non-structural fills, horticulture etc.

Aggregate is a broad term, which includes aggregate obtained from (a) natural sources, (b) aggregate produced from natural materials & (c) the synthetic versions. The natural aggregate type (a) in the form of sand and gravel may be obtained from river-beds or from pits in ground or obtained by crushing of large blocks of stone collected from natural stone quarries. The aggregate type (b) is obtained by processing of naturally occurring materials like clay, shale, slate etc. The third version (c) is called “synthetic Aggregate”, which in its inorganic form include “Foamed Slag”, “Sintered pulverized fuel ash”, “Aardelite”, “Ilmenite”etc.

It is but evident that various types of aggregate meet the needs of different kinds of field applications. The low density aggregate normally exhibit better thermal performance, while the heavier density version is more suited for structural applications. The aggregate from natural sources accounts for the bulk of the normal consumption. The version obtained by processing of natural materials primarily caters to the special requirements of lightweight aggregate. The synthetic version is a new trend in industry, primarily aimed at conserving the environment and making productive use of industrial waste bye products. This invention relates to synthetic (Man Made) version of aggregate and attempts to contribute towards the objectives mentioned above, by reducing degradation of natural resources through provision of substitute aggregate produced from environment polluting industrial waste products like “Pulverized Fuel Ash” and/or stone dust left stockpiled at stone crushers after sale of regular sized aggregate.

2. Discussion of the Background Art

My invention differs from the present art on account of factors as discussed hereinafter. Most of the available patents facilitate production of Man Made aggregate alternative in a limited range of densities and sizes while my invention enables production of a much wider density range as well as in predetermined sizes of the aggregate. Examples of Man Made aggregate using prior art are LYTAG and AARDELIT. LYTAG is a lightweight aggregate, produced by palletizing Pulverized Fuel Ash (PFA), which is then heated on a sinter strand at around 1250° C. The aggregate formed vary in size from 14 mm down and the bulk dry density is typically in the range of 750-850 kg/m³. AARDELITE is another lightweight aggregate produced by palletizing a mix of fly ash, lime, water and gypsum and then cured in autoclaves. My invention, however, enables production of aggregate from waste materials including fly ash under ambient conditions thus warranting a very limited energy input.

Likewise Styron's U.S. Pat. No. 4,624,711 for manufacture of Lightweight Aggregate from fly ash, surfactant foam, accelerator and some additives warrants use of agglomeration process for forming of palletized aggregate, to be subsequently fired at 1,800° F. or alternatively at 300° F. Styron's other low energy input process as per U.S. Pat. No. 4,741,782 uses fly ash, cement, some filler, water and chemical accelerator, but still involves processing of ingredients through a pelletizing device and subsequent curing of aggregate pellets in oxygen containing gas at temperature of 300° F. My invention uses different input materials and also does not make use of pelletization or curing at elevated temperature.

Another U.S. Pat. No. 4,377,414 by Buschmann et. al. using fly ash as an input material relates to production of definite shaped articles like pellets, bricks, blocks, tiles and the like by a closely controlled compaction process directly from fly ash containing powder produced in a lime based scrubbing process for removal of fly ash & SO₂ from flue gases. Moreover the patent does not relate to production of aggregate. The raw materials and the output of my patent are also quite different from this.

U.S. Pat. No. 4,659,385, which deals with the production of Aerated Concrete, which can be handled and fabricated like ordinary concrete. The current invention on the other hand uses different ingredients and deals with production of specific sizes of aggregates of desired density. Likewise my invention differs from the Walker's U.S. Pat. No. 4,770,831 for manufacture of lightweight aggregate both in the choice of input materials as also the process of manufacture. Walker uses fly ash with 1%-5% lime milk as a binder and palletizes the same at a temperature of 45° C. to 100° C. and subsequently cures the granules between 50° C. to 85° C. My invention on the other hand uses cement as a binder, makes no use of pelletization and propagates curing at ambient temperature.

Weber's U.S. Pat. No. 5,484,479 propagates a process of making synthetic aggregate by mixing class-C fly ash with controlled feed of water spray and sugar based admixtures, consolidating the mixed soil like mass into a flat slab, allowed to set, which is subsequently broken and crushed into aggregate. Similarly Ivokovich's U.S. Pat. No. 5,704,972 proposes use of “C” or “F” Fly ash, hydrated lime 2%-10% and 3% to 12% alkali hydroxide, making slurry with 10-25% water, compacting slurry, introducing it into a rotary kiln for 2-30 minutes where it is heated to 150° F. to 1000° F. The pellets formed are removed to be there after crushed into aggregate of required size. In another version the slurry is allowed to fall on a flat surface, roller compacted, cured and thus hydrolyzed product allowed to stay till it reaches predetermined compression level, where after it is excavated, crushed and screened to make desired sizes of aggregate. The preferred mix of this patent has also been advocated in Gerbus's U.S. Pat. No. 6,126,738, but Gerbus has proposed dropping the wet mixture into conical piles using a radial stacker. The U.S. Pat. No. 5,762,864 by Park deals with making lightweight aggregate from waste products like stone aggregate sludge, stone fragments & sewage plant sludge in 50:50 ratio, making sludge spheroids in rotary plate device, applying paper sludge on to the surface of these spheroids and then burning them at a temperature between 1,000° C.-1,200° C. in a furnace and then cooling them. My invention also differs from all these in choice of raw materials and even in the process of manufacture.

### SUMMARY OF INVENTION

An apparatus and method for production of synthetic lightweight aggregate in controlled sizes and in wide range of densities from fine grained waste products like fly ash, crusher dust etc. Predetermined quantities of cement, sand, fly ash and/or stone dust, additive and water are mixed into a homogeneous consistency. Then appropriate quantity of preformed stable foam prepared from diluted foaming agent and compressed air is added into the mixer and further mixed into homogeneous slurry. This mixed slurry is then poured, made to flow and cast into multiple spheroid shaped cells of specially designed battery moulds for predetermined size and density, where they are allowed to set into aggregate. Opening-up of the batteries enables release and fall of aggregate into separate collection pits for each size of aggregate. The collected aggregate is further cured like any other concrete product with mist/water spray under ambient conditions till maturity and then dispatched to project sites.

### BRIEF DESCRIPTION OF DRAWINGS

FIG. 1 depicts the assembly details of a typical battery mould having provision of multiple interconnected cells for simultaneous casting of a large number of specific sized aggregate. The figure shows Elevation, Plan, Side View and Sectional Elevation A-A at a typical junction of plates & another Sectional view B-B through middle of one of the multiple plates.

FIG. 2 depicts various stages in the production process. The selection of the input raw materials is from amongst Cement (A), Fly Ash (B), Stone Dust (C), Sand (D). Additive (E), Water (F) and appropriate quantity of preformed foam (K), stable under ambient conditions for a duration much beyond the final setting time of Portland cement, The input raw materials are stored in appropriate silos/bins/tanks. The preformed foam (K) of requisite quality is freshly generated and supplied when required, by a Foam Generator (1), from a mixture of selected grade of Foaming Agent (G), Water (E) and Compressed Air (H).

The process begins with feeding into the mixer (M) of properly batched quantities of specific raw materials from amongst (A), (B), (C), (D), (E) & (F) required for a particular type and density of aggregate being produced. Once the slurry in the mixer becomes homogeneous, required quantity of pre-formed stable foam (K) is then fed into the mixer and mixing continued for a little while to ensure thorough mixing of foam with the mortar mix.

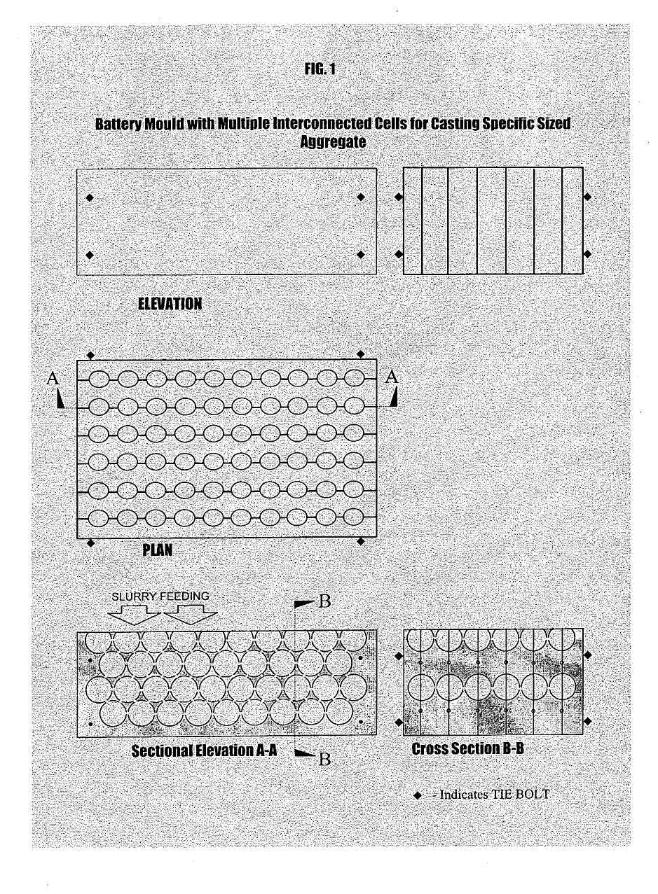

The mixed slurry is then fed on to top of different assemblies of multiple cell battery moulds (N-1), (N-2), (N-3), (N-4), (N-5) etc., for casting different sized aggregate of desired density. The details of Battery moulds have been shown in FIG. 1. The innumerable minute air bubbles in the fluid slurry of fine materials act as ball bearings and enable it to flow down due to gravity into the inter-connected spheroidal shaped multiple cells of different sized aggregate and fill them up. Subjecting the battery moulds to minor external vibration would hasten the flow and filling time gets substantially reduced. The filled slurry mix in the cells of the batteries is allowed to set for some time under ambient conditions, where-after when the battery plates are opened one after another, the hardened granules of different sized aggregate fall down into collection pits P1, P2, through Pn etc., from where these are removed for further maturity before dispatch.

### DETAILED DESCRIPTION

Preparation of Battery Molds

A set of pre-molded or duly fabricated plates of a hard durable material of one specific thickness is assembled for each size of aggregate to be produced. The internal plates have on their two surfaces, mirror imaged pre-molded or drilled out semi-spherical depressions, to a depth slightly less than the radius of target spherical size of aggregate. These molded depressions are created in a staggered zigzag pattern, as shown in Section-AA FIG. 1, and are inter-connected with minor channels along the surface and small holes across two faces near the bottom of depressions. These depressions fall short of the two sides and the bottom of the plates to ensure leak-proof-ness. The two end plates of slightly lower thickness have the matching molded depressions and minor channel depressions on the internal surfaces only as shown in Plan of FIG. 1. An assembly of a number of intermediate plates and two end plates duly bolted together constitutes one battery mould for casting one specific sized aggregate. The upper sides of the plates in the assembled battery are so cut as to expose almost half the depth of the cup shaped depressions. The multiple rows of circular holes so created on the top surface of the assembled batteries serve as inlets for the flow of mixed slurry into multiple cells inter-connected to the top holes inside different battery forms.

The batteries could alternatively also be so designed that instead of mixed slurry being fed from the holes formed on top surface created with the assembly of multiple plates held vertically, it could be organized from the top surface of a set of duly prepared and assembled battery of plates held horizontally. The length and depth/breadth of plates and their numbers in one battery depends on the scale of production and the available handling facilities. Likewise the number of batteries for each size of aggregate to be produced would depend on the cycle time of operations and required quantum of daily output of that size.

Such sets of battery moulds of different depths of molded depressions are prepared for required size range of aggregates and their target daily output. Each battery mould is either provided with an in-built or has a provision for affixing a vibration mechanism when required or the battery could be transferred to a vibrating table during the filling operation.

Preparation of Batteries for Casting

The molded/fabricated plate surfaces of each set of battery moulds are pre-coated with appropriate de-molding agent and then assembled into a battery in readiness for the actual casting/filling/molding operation.

Preparation of Fluid Slurry Mix for Casting

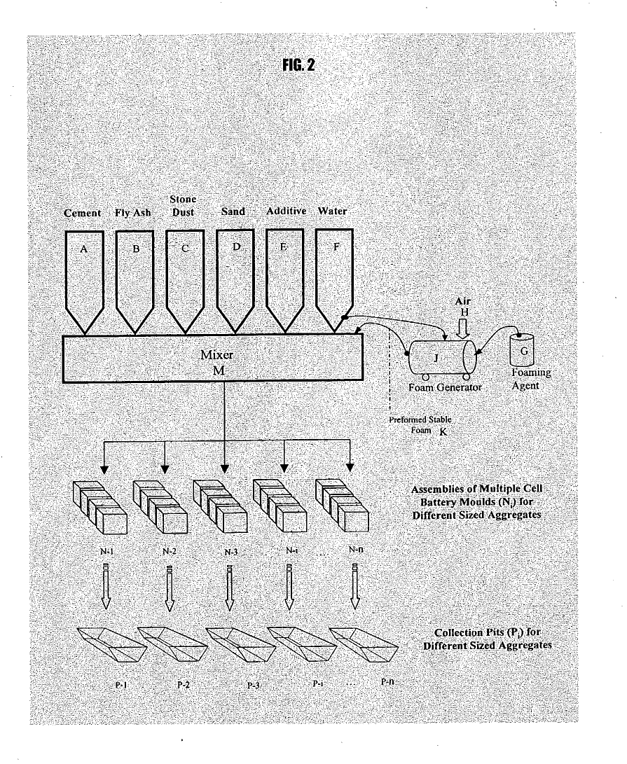

Various stages in the production process have been depicted in FIG. 2. The primary input raw materials are Cement (A), Fly Ash (B), Stone Dust (C), Sand (D), Additive (E) for accelerating the hardening process if required, Water (F) and Preformed foam (K), stable under ambient conditions. This foam (K) of requisite quality in desired quantity is freshly generated and supplied as and when required through a Foam Generator (H) from a mixture of selected grade of Foaming Agent (G) like NEOPOR-600 ® or equivalent, Water (E) and Air (H) duly compressed and used by the Foaming Generator (J). The raw materials are stored in appropriate silos/bins/tanks. Cement should preferably be high-grade Portland variety. Fly ash to preferably be of class F to economize on cost of production, though Class C may also be used. The pre-formed foam has to be stable for duration much beyond the final setting time of Portland cement, so that the structure of the aggregate being cast in the forms using this foam does not collapse during the hardening stage.

The process begins with feeding into the mixer (M) of properly batched quantities of specific raw materials from amongst (A), (B), (C), (D), (E)& (F) required for a particular type and density of aggregate being produced. The lower target density output would primarily involve deployment of Cement, fly Ash, Water, Hardening agent and higher proportion of Foam. The higher density outputs would apart from Cement+Fly ash as binders also involve higher input of Stone Dust/Sand, but much lower input of foam. Once the slurry in the mixer becomes homogeneous, required quantity of pre-formed stable foam (K) is then fed into the mixer and mixing continued for a little while to ensure thorough mixing of foam with the mortar mix.

Feeding of Batteries and Maturing of Filling

The mixed slurry is then fed on to top of different assemblies of multiple cell battery moulds (N-1), (N-2), (N-3), (N-i), (N-n) etc., for casting different sized aggregate of desired density. The details of Battery moulds have been shown in FIG. 1. The innumerable minute air bubbles in the fluid slurry of fine materials act as ball bearings and enable it to flow down due to gravity into the inter-connected flattened sphere shaped multiple cells for different sized aggregate. Subjecting the battery moulds to minor external vibration would accelerate the flow of slurry into various empty cells up-to the bottom of forms, filling these up and thereby pushing out entrapped air from these cells.

The filled material is allowed to mature till final setting time of the cement binder and consequent hardening of the filling under ambient conditions. This maturity period may be shortened through addition of approved early hardening admixture or adoption of any of the well-known accelerated curing techniques.

Opening of Batteries and Collection of Hardened Granules and Some Fines

The battery moulds are ready to be opened-up the moment filled slurry has achieved adequate hardening. The individual plates of the battery are separated one after another enabling the hardened globules of filled material to fall on to bins on the floor. These collection bins can be made to slope away from the production area. The batteries of different sized aggregates are emptied into separate bins.

A little quantity of small sized grains is also produced along-with the specific sized aggregate. This is the bye product from the small sized inter-connecting channels between the cut-outs/depressions for the aggregate nodules. This small sized material is segregated from the aggregate and collected separately to serve as low-density sand for superior insulation plasters.

The aggregate so produced and collected from the ground bins is subjected to further mist/water spray curing and maturing, like any other concrete product, before delivery to the clients for use in their works.

Cleaning and Re-Assembly of Battery Moulds

The opened-up plates of each battery are cleaned of any sticking slurry. The plate surfaces are once again film coated with appropriate de-molding agent and re-assembled into batteries ready to go through the cycle of operations once again.

Repetitive Uses of Battery Moulds Feasible Each Day

It is easily feasible to have multiple uses of each battery mould, in a 24-hour cycle of day, depending on the selection of the initial hardening process.

Shape of Output Aggregate

The primary output of the process is aggregate of specific size and density with somewhat flattened spherical shape i.e. spheroidal. The cross section of the aggregate is circular in the plane of casting plates, while it is elliptical in the other two planes at right angle to the surface of these casting plates.

This process is more economical for production of larger sized aggregate, which is difficult to produce as per currently available other technologies. Therefore another way of obtaining a range of smaller sized lightweight aggregate in crushed form is to subject the larger sized granules as obtained above, to subsequent process of crushing and segregation through sieving into different size ranges.

What is claimed is:

1. An apparatus, in the form of a battery mould, for simultaneous casting of large quantity of specific sized artificial or man made aggregate comprising: an assembly of a number of plates, where each face of the intermediate plates and the inner faces of the end plates have predetermined pattern of large number of depressions of specific shape and size depending on the size of aggregate being produced, the depressions being so made as to fall short of the plate edges on the sides and the bottom, but are partially sheared off near the top to enable formation of small chambers for inflow of mix slurry and where the said depressions are inter-connected through small channels; an assembly such that when face of one plate is joined with the face of another plate having matching mirror image depressions and channels on it's surface, they create a large number of interconnected cells of desired aggregate size along the junction of these plates so that every addition of a matching plate surface adds an equal number of inter-connected cells; the assembly of such plates being continued till a battery with adequate number of plates of target output capacity for one specific size of aggregate has been put together and bolted, thus ready for casting of aggregate pieces by feeding slurry from the top.

2. The apparatus of claim 1, wherein the design is such as to allow for external vibration, if needed.

3. The apparatus of claim 1, wherein the design of the said channels, interconnecting the cells, is such that their length, width and depth is very small.

4. The apparatus of claim 1, wherein the size of channels is such that it is just adequate to allow for smooth flow of mix slurry between various inter-connected cells.

5. The apparatus of claim 1, wherein the size and length of said inter-connecting channels is such that it does not significantly impact the final shape of the artificial or man made aggregate ultimately produced.

6. The apparatus of claim 1, wherein the design of each cell is such that it enables easy demoulding of cast aggregate pieces after the hardening of mix, when the battery moulds are opened-up.

7. The apparatus of claim 1, wherein the design of depressions in the plates and the shape of the said cells on assembly of plates is such that it enables casting of spheroidal or other variants in shape of man made aggregate.

8. The apparatus of claim 1, wherein the design allows the production of specific sized aggregate as big as 80 mm or even higher.

9. The apparatus of claim 1, wherein the design allows the production of aggregate of one or even more predetermined sizes from one such assembly.

10. A production process for forming man made aggregate comprising: preparing a slurry mix of cement, fine materials, additives, water and preformed foam such that the ball bearing effect of minute foam bubbles enables a smooth flow of the slurry mix; transferring and feeding the said slurry mix to a battery mould of interconnected cells from the top of the battery moulds, the smooth flow of the slurry mix to the plurality of interconnected cells being aided by gravity and the ball bearing effect of minute foam bubbles present in the slurry mix, the flow being additionally aided by external vibration to speed up production if so required, filling up all cells completely and driving entrapped air out of the cells; where after the filled material is allowed to set under ambient conditions; the batteries being opened-up after a few hours, on adequate hardening of the cast aggregate pieces, enabling them, along with some finer material from the small interconnecting channels between cells, to drop down into collection pits, from where the output is transferred for further curing, maturing and delivery to user sites, rendering the battery moulds free for cleaning, re-assembly and repetition of the casting cycle.

11. The process of claim 10, such that the composition of the slurry mix is selected in such a way so as to prepare finished aggregate of a predetermined target density.

12. The process of claim 10, such that the plurality of said battery moulds are arranged in separate production lines as per size of aggregate being produced.

13. The process of claim 10, such that it enables casting of the man made aggregate in one single operation, unlike the currently available art warranting multiple processing steps.

14. The process of claim 10, such that it is performed under ambient conditions requiring no conglomeration or compression.

15. The process of claim 10, such that it enables production of artificial aggregate in much wider range of bulk densities say from 250 kg/m3 to 1,800 kg/m3.

16. The process of claim 10, such that it can be performed even at construction sites.

17. The process of claim 10, such that it can be performed utilizing un-skilled labor.

18. The process of claim 10, such that it is environment friendly by not creating any pollution in the execution of the process.

19. The process of claim 10, such that it is environment friendly by making productive use of waste industrial products including but not limited to fly ash, stone dust etc. as input raw materials.

20. The process of claim 10, wherein man made aggregate of crushed form in different densities and sizes are produced, by further subjecting the initially produced regular shaped aggregate to subsequent crushing and sieving.

21. A process of claim 10, such that the bye product of fine grained material, which gets cast and set in the said inter-connecting channels between aggregate cells but separates from the aggregate pieces when the entire output falls down into the said collection pits, can be deployed as a raw material for insulation plastering.
